(19) United States
(12) Patent Application Publication
(10) Pub. No.: US 2005/0019420 A1
(43) Pub. Date: Jan. 27, 2005

(54) Fungicide composition comprising pyrimethanil and at least a phosphorous acid derivative and use thereof for fighting against plant diseases

(76) Inventor: Patrice Duvert, Lyon (FR)

Correspondence Address: OSTROLENK FABER GERB & SOFFEN, 1180 AVENUE OF THE AMERICAS, NEW YORK, NY, 100368403, US

(21) Appl. No.: 10/494,868

(22) PCT Filed: Nov. 8, 2002
(86) PCT No.: PCT/FR02/03832

(30) Foreign Application Priority Data
Nov. 8, 2001 (FR) 01 14439

(51) Int. Cl. A01N 59/26; A01N 43/54

(52) U.S. Cl. 424/601; 514/269

(57) ABSTRACT

The present invention relates to a fungicidal composition comprising pyrimethanil and at least one phosphorus and more especially phosphorous acid derivative, and the use of such a composition combining these active compounds for controlling plant diseases or for controlling the phytopathogenic fungi present or capable of appearing on plants, such a combination allowing in particular extension in time of the activity of pyrimethanil.

### DESCRIPTION

The present invention relates to a fungicidal composition comprising pyrimethanil and at least one phosphorus and more especially phosphorous acid derivative, and the use of such a composition combining these active compounds for controlling plant diseases or for controlling the phytopathogenic fungi present or capable of appearing on plants, such a combination allowing in particular extension in time of the activity of pyrimethanil.

Pyrimethanil is a fungicidal compound which is widely known and in particular which is described in the book entitled The Electronic Pesticide Manual (Twelfth Edition) version 2.0 (by British Crop Protection Council, published by Clive Tomlin).

Moreover, French patent application No. 2 692 108 which essentially relates to mixtures based on pyrimethanil and numerous other compounds gives a list of more than eleven types of families of fungicidal compounds and of more than 70 candidate compounds for the mixture; among this systematic list of compounds, only 23 mixtures have led to laboratory experimentation, none under open field conditions. The mixture of pyrimethanil and phosphorus (and in particular phosphorous acid) derivative(s) is not at all mentioned or even suggested in this document. Such a mixture has never been produced, much less tested.

Among the phosphorus derivatives known as fungicides are the phosphorous or phosphonic acid derivatives such as phosphorous acid and its alkali or alkaline-earth metal salts, metal phosphites (Al, Na) including in particular fosetyl-Al. This fungicide is widely known and is marketed in particular under the name Aliette®. Fosetyl-Al is monoethyl ester-phosphonate-aluminum which is described in particular in the following patents: DE-B-2 456 627, US-B4 139 616, and US-B-4 143 059, and in “The Pesticide Manual”, a World Compendium, 11th edition, C. D. S. Tomlin, British Crop Protection Council, No. 599.

Moreover, Japanese patent application No. 05112408 describes combinations of fungicidal compounds chosen from two groups. The first group comprises 2-anilino-4-methylpyrimidine type derivatives of which 7 are given as an example while the second group relates to five other known fungicidal compounds which are 2,6-dichloro-4-nitroaniline, iprodione, procymidone, fosetyl-Al and polyoxin. However, the specific combination of pyrimethanil and a phosphorous acid derivative is not described in this document whose aim is to provide a means of anti-fungal control which has a broad spectrum or a synergistic effect.

The extension in time of the efficacy of pyrimethanil in the combination of the present invention is not at all disclosed or suggested in any of these documents.

In the field of fungal activity, in particular for the protection of crops, one of the problems at the heart of the research studies carried out in this technical field is the improvement of performances, in particular in terms of fungal activity and especially in terms of maintaining this fungal activity over time.

Naturally, the fungicides useful in protecting plants against fungi should be endowed with an ecotoxicity which is reduced to the minimum, knowing that the users of fungal active ingredients, as well as the consumers of the products derived from these crops, are increasingly aware.

In addition, from a toxicological point of view, fungicides should as far as possible be neither dangerous nor toxic during their use.

Furthermore, it is advantageous for fungicides to have a broad activity spectrum.

The economic factor should of course not be overlooked in the search for novel fungicides.

The corollary of all this is that it is always desirable to reduce the doses of chemical products spread in the environment for controlling fungal attacks on crops, in particular by reducing the doses at which the products are applied and/or the frequency of application.

Without this being limiting, attention is more particularly paid in the context of the invention to the protection of crops against infestation by fungi, such as gray mold, altemaria diseases, scabs, monilia diseases or cercospora diseases, the crops most particularly affected being fruit or vegetable crops including grapevine, arboriculture, banana and various vegetables.

Another advantage of the present invention is to allow better management of the phenomena of resistance of phytopathogenic organisms of crops against known antifungal active ingredients.

Another difficulty relating to the use of numerous fungal materials lies in the accumulation of several of the problems which have just been set out. It is indeed even more difficult to solve the problems posed when they accumulate because the solutions which may be envisaged are sometimes antinomical or even antagonistic.

One aim of the invention is therefore to provide a novel fungicidal composition which is useful for solving the problems set out above, in particular a composition which makes it possible to improve the persistence of action of pyrimethanil.

Another aim of the invention is to provide a novel fungicidal composition which is useful in the preventive and curative treatment of fungal diseases, for example of fruit or vegetable crops including grapevine, arboriculture, banana and the crops of various vegetables.

Another aim of the present invention is to provide a fungicidal composition possessing preventive, curative, eradicant and antisporulant properties.

Another aim of the present invention is to allow the use of phosphorous acid derivatives, such as fosetyl-Al, and of phosphorous acid itself against diseases affecting arboricultural crops and in particular scab.

Another aim of this invention is to allow the treatments applied to crops to be spaced out or even to allow the elimination of a number of these treatments.

Other aims of the invention will appear in the disclosure of the invention which follows.

Surprisingly, it has been discovered that all these aims, among others, may be achieved completely or partly by means of the fungicidal compositions which are the subject of the present invention, combining as active agents pyrimethanil and at least one phosphorus derivative, advantageously at least one phosphorous acid derivative.

The persistence of the fungicidal effects which the invention makes it possible to achieve has as beneficial effect the reduction of the doses and of the number of applications required.

Preferably, the phosphorus derivative is a phosphorous acid derivative, preferably chosen from the group comprising phosphorous acid derivatives such as metal phosphites such as fosetyl-Al, fosetyl-Na, phosphorous acid and its alkali or alkaline-earth metal salts, and mixtures thereof; fosetyl-Al and fosetyl-Na being more particularly preferred as well as phosphorous acid itself. These particular combinations have proved very advantageous for pyrimethanil-other compound ratios ranging from 0.1 to 1.

References to methods for preparing such compounds will be found in the book cited above. In the composition according to the invention, the ratio of the quantities of pyrimethanil and of phosphorous acid derivative generally ranges from 0.0005 to 250, preferably from 0.05 to 10, and still more preferably from 0.05 to 1.

However, ratios of these compounds ranging from 0.1 to 10, preferably from 0.1 to 6, still more preferably from 0.1 to 1, have proved even more advantageous.

A composition according to the invention which is particularly advantageous comprises pyrimethanil and fosetyl-AI in a ratio ranging from 0.1 to 10, preferably from 0.1 to 6, still more preferably from 0.1 to 1.

Usually, the compositions according to the invention comprise between 0.00001 and 100%, preferably between 0.001 and 80%, of active compounds, whether these compounds are combined, or whether they are in the form of two active ingredients used separately.

Unless otherwise stated, the proportions and percentages used or described throughout the present description and in the claims which will follow are proportions or percentages by weight.

For their use in practice, the active substances of the composition according to the invention are rarely used alone.

Thus, for their use, these active ingredients are usually combined with a solid or liquid carrier which can be used in particular in the agricultural field, and optionally with at least one surfactant and/or one or more auxiliary agents.

In particular, as carriers, there may be used inert and customary carriers; likewise, as surfactants, there may be used the customary surfactants in the field of formulation of compositions, which are intended for agricultural use, in particular for the treatment or protection of crops such as those of the present invention.

According to another embodiment of the present invention, the various fungicidal compositions according to the invention which have been described up until now may also be in the form of tank mixes.

These fungicidal compositions in the form of tank mixes are usually in the form of dilute fungicidal compositions.

Most often, these so-called tank mix fungicidal compositions are mixed in the reservoir of the application device.

Usually, the fungicidal compounds used in the compositions according to the invention are therefore combined with one or more carriers and/or one or more substances useful for their formulation. Thus, where appropriate, the compositions according to the invention may comprise up to 99% of carrier and/or up to 25% of one or more surfactants and/or up to 25% of one or more formulating agents.

In the present disclosure, the term carrier designates a natural or synthetic, organic or inorganic material with which the active ingredient(s) is(are) in the compositions according to the invention, in particular to facilitate their application to a plant, a fruit or alternatively to seeds or to the soil.

This carrier is therefore generally inert and should most often be acceptable in agriculture, in particular by the treated plant or by the fruits of this plant in the broad sense.

As examples of solid carriers which can be used, there may be mentioned natural or synthetic silicates, resins, waxes, fine powders or granules of clay, in particular kaolinic clay, diatomaceous earth, bentonite or acidic clay, synthetic silicon oxide hydrate, talcs, ceramics, other minerals including sericite, quartz, sulfur, activated charcoal, calcium carbonate, hydrated silica, or alternatively industrial fertilizers such as ammonium sulfate, ammonium phosphate, ammonium nitrate, urea or ammonium chloride, natural or synthetic silicates, resins, waxes, talc, lime, quartz, attapulgite, montmorillonite, bentonite or diatomaceous earth, alumina, or silicates, natural, pounded or crushed rocks, such as calcite, marble, pumice stone, sepiolite, and dolomite; synthetic granules of inorganic or organic flours; granules of organic material such as sawdust, coconut husk, maize ear or covering or tobacco stalk; kieselguhr, tricalcium phosphate, powdered cork, or adsorbent charcoal; water-soluble polymers.

As examples of liquid carriers which can be used, there may be mentioned water, alcohols and in particular methanol or ethanol, ketones and in particular acetone, methyl ethyl ketone or cyclohexanone, petroleum fractions, aromatic hydrocarbons including benzene, toluene, xylene, ethylbenzene or methylnaphthalene, nonaromatic hydrocarbons including hexane, cyclohexane, kerosene or gas oil, liquefied gas, esters including ethyl acetate and butyl acetate, nitriles including acetonitrile and isobutyronitrile, ethers including diisopropyl ether or dioxane, amides including N,N-dimethylformamide or N,N-dimethylacetamide, halogenated hydrocarbons including dichloromethane, trichloroethane or carbon tetrachloride, dimethyl sulfoxide, vegetable oils including soybean oil or cottonseed oil.

The surfactant(s) may be emulsifying, dispersing or wetting agents of the ionic or nonionic type.

It is possible, for example, to mention salts of polyacrylic acids, salts of lignosulfonic acids, salts of phenolsulfonic or naphthalenesulfonic acids, polycondensates of ethylene oxide with fatty alcohols or with fatty acids or with fatty amines, substituted phenols, in particular alkylphenols or arylphenols, salts of sulfosuccinic acid esters, derivatives of taurine, in particular alkyl taurates, phosphoric esters of polyoxyethylated alcohols or phenols; it is possible to mention most particularly alkyl sulfonate salts, alkylaryl sulfonates, alkylaryl ethers, polyoxyethylenic derivatives thereof, polyethylene glycol ethers, polyalcohol esters, derivatives of sugars, alcohols and the like. The presence of at least one surfactant is generally essential when at least one of the active ingredients and/or the inert carrier are not soluble, in particular in water, in the-case where the carrier agent for the application is water.

In the compositions according to the invention, it is also possible to combine with the active compounds all sorts of other ingredients or agents such as, for example, protective colloids, adhesives, thickening agents, thixotropic agents, penetrating agents, colorants such as inorganic pigments, preservatives, flavorings, antigels, stabilizing agents including isopropyl hydrogen phosphate, 2,6-di-tert-butyl-4-methylphenol, 2-tert-butyl-4-methoxyphenol and 3-tert-butyl-4-methoxyphenol, vegetable or mineral oils, fatty acids or esters thereof, sequestering agents, dispersing agents including casein, gelatin, saccharides and in particular starch powder, gum arabic, certain derivatives of cellulose or alginic acid, derivatives of lignin, bentonite, synthetic polymers soluble in water, in particular polyvinyl alcohol, polyvinylpyrrolidone, polyacrylic acids, as well as other active ingredients known for their pesticidal, in particular insecticidal or fungicidal, properties; or for their plant growth promoting properties, in particular fertilizers; or for their insect or plant growth regulating properties.

Moreover, the fungicidal compositions according to the invention may take fairly diverse forms, in particular they may be in solid or liquid forms. Thus, the compositions according to the invention may take numerous forms of formulations; thus, these compositions comprising the active compounds may be used in the form of an aerosol dispenser; suspension of capsules; cold fogging concentrate; dustable powder; emulsifiable concentrate; aqueous/aqueous type emulsion; oil/inverse type emulsion; encapsulated granule; fine granule; suspension concentrate for seed treatment; granule; hot fogging concentrate; macrogranule; microgranule; oil-dispersible powder, oil miscible suspension concentrate; oil-miscible liquid; paste; plant rodlet; powder for dry seed treatment; seed coated with a pesticide; smoke candle; smoke cartridge; smoke generator; smoke pellet; smoke rodlet; smoke tablet; smoke tin; soluble concentrate; soluble powder; solution for seed treatment; suspension concentrate (=flowable concentrate); ultra low volume liquid; ultra low volume suspension; vapor releasing product; water-dispersible granules or tablets; water dispersible powder for slurry treatment; water-soluble granules or tablets; water-soluble powder for seed treatment; wettable powder; as well as possible mixtures, associations or combinations of these various forms.

Apart from pyrimethanil and at least one phosphorus or phosphorous acid derivative such as fosetyl-Al, the composition according to the invention may also comprise other active compounds and in particular one or more active compounds which are useful for protecting plants against pests.

Among such active compounds, the composition according to the invention may therefore comprise one or more insecticidal, herbicidal or fungicidal compounds or growth regulating compounds.

Among the additional fungicidal active ingredients which may be used alone or in combination with other active ingredients, in particular pesticides, in the composition according to the invention, there may be mentioned 8-hydroxyquinoline sulfate; AC 382042; Ampelomyces quisqualis; azaconazole; azoxystrobin; bacillus subtilis; benalaxyl; bitertanol; blasticidin-S; Bordeaux mixture; bromuconazole; bupirimate; carboxin; calcium polysulfide; captan; carbendazim; carpropamid (KTU 3616); CGA 279202; chinomethionat; chlorothalonil; chlozolinate; copper hydroxide; copper naphthenate; copper oxychloride; copper sulfate; copper oxide; cymoxanil; cyproconazole; dichlofluanid; diclocymet; dicloran; diethofencarb; difenoconazole; difenzoquat; difenzoquat metilsulfate; diflumetorim; dimethirimol; dimethomorph; diniconazole; diniconazole-m; dinocap; diphenylamine; dithianon; dodemorph; dodemorph acetate; dodine; dodine free base; edifenphos; epoxiconazole ethasulfocarb; ethirimol; etridiazole; famoxadone; fenamidone; fenarimol; fenbuconazole; fenfuram; fenhexamid; fenpiclonil; fenpropidin; fenpropimorph; fentin acetate; fentin hydroxide; ferimzone; fluazinam; fludioxonil; fluoroimide; fluoxastrobin; fluquinconazole; flusilazole; flusulfamide; flutolanil; flutriafol; folpet; formaldehyde; fuberidazole; furalaxyl; gliocladium virens; guazatine; guazatine acetates; GY-81; hexachlorobenzene; hexaconazole; hymexazol; IKF-916; imazalil; imazalil sulfate; imibenconazole; iminoctadine; iminoctadine triacetate; iminoctadine tris[albesilate]; ipconazole; iprobenfos; iprodione; iprovalicarb; kasugamycin; kasugamycin hydrochloride hydrate; kresoxim-methyl; mancopper; mancozeb; maneb; mepronil; metalaxyl; metalaxyl-M; metam-sodium; metconazole; methasulfocarb; methyl isothiocyanate; metiram; metominostrobin metrafenone; MON-65500; naphthenic acid; natamycin; nicobifen; nitrothal-isopropyl; nuarimol; octhilinone; ofurace; oleic acid (fatty acids); oxadixyl; oxine-copper; oxycarboxin; penconazole; pencycuron; pentachlorophenol; pentachlorophenyl laurate; perfurazoate; phlebiopsis gigantea; phthalide; piperalin; polyoxine b; other polyoxines; polyoxorim; potassium hydroxyquinoline sulfate; probenazole; prochloraz; procymidone; propamocarb; propamocarb hydrochloride; propiconazole; propineb; prothioconazole; pyraclostobin; pyrazophos; pyributicarb; pyrifenox; pyroquilon; quinoxyfen; quintozene; secbutylamine; sodium 2-phenylphenoxide; sodium pentachlorophenoxide; spiroxamine; streptomyces griseoviridis; sulfur; tebuconazole; tetraconazole; thiabendazole; thifluzamide; thiophanate-methyl; thiram; tolclofos-methyl; tolylfluanid; triadimefon; triadimenol; triazoxide; Trichoderma harzianum; tricyclazole; tridemorph; triflumizole; triforine; triticonazole; validamycin; vinclozolin; zinc naphthenate; zineb; ziram; zoxamide; the compounds having the chemical name (E, E)-2-(2-(1-(1-(2-pyridyl)propyloxyimino)-1-cyclopropylmethyloxymethyl)phenyl)-3-methoxy-propenoate de and 3-(3,5-dichlorophenyl)-4-chloropyrazole, 1H-pyrazole4-carboxamide, 1-methyl-N-[3-(4-methylphenyl)-2-thienyl]-3-(trifluorine) whose development code is MTF-753.

According to another equally advantageous aspect, the present invention also relates to a method for the curative or preventive control of phytopathogenic organisms of plants; such a method according to the invention is based on the use of at least one composition or of at least one combination according to the invention.

This method is particularly advantageous in that it comprises a novel use of a phosphorus derivative to significantly improve the persistence of the action of pyrimethanil.

Such a use has never been described up until now.

In the context of this novel application, the use of phosphorous acid or one of its derivatives as described above is preferred. The preferred phosphorous acid derivative is fosetyl-Al.

During their use according to the invention, the active compounds used are used in pyrimethanil/phosphorus derivative ratios such as those described above for the composition according to the invention.

Among the procedures or methods of treatment and/or protection according to the invention, those which are used for the treatment and/or protection of crops are preferred, and among such methods or procedures, those for the protection of crops are most particularly preferred.

Said use of the methods according to the invention may be carried out according to various forms and in particular using a fairly wide variety of modes of application, but also according to various techniques of application, or alternatively for the protection of various types, varieties or families of vegetables or plants, or alternatively for combating or controlling various types of phytopathogenic organisms.

As regards the various modes of application usefully employed during the methods according to the invention, simultaneous, separate, alternate or sequential modes of application are in particular possible.

Nevertheless, most often, the modes of application useful during the methods according to the invention and which are preferred consist of modes of simultaneously applying the active compounds.

However, a relatively advantageous variant of the method according to the invention uses an alternate mode of application of the active compounds.

Another mode of application useful for carrying out the methods according to the invention relates to the sequential application of the fungicidal compounds; such a sequential mode of application may in particular take the form of several applications of pyrimethanil, followed by several applications of phosphorous acid derivative(s).

Quite obviously, the reverse sequential mode of application consisting in several applications of phosphorous acid derivative(s), followed by several applications of pyrimethanil, also forms part of the methods of the present invention.

The various variants of carrying out the methods according to the invention which have just been described may also be combined or associated, completely or partially, with each other.

Persons skilled in the art will easily know how to determine the associations or combinations of modes of application according to the invention which are best suited to the use of the active compounds which they envisage.

In addition to the various embodiments of the methods according to the invention which have just been described, said methods can also use a fairly large number of application techniques; thus, as said techniques, there may be mentioned in particular dusting, dipping, spraying, smoking or fogging.

During the application of the active compounds of the composition according to the invention by dipping, in particular of fruits, the solution used advantageously comprises from 0.01 to 1% of active ingredients, preferably from 0.1 to 1.0%, and still more preferably from 0.05 to 0.2%.

Other variants of the modes of application useful for the methods according to the invention exist, particularly depending on the part(s) of the plant or vegetable which are treated or which are to be treated.

Thus, the methods according to the invention may be carried out for the treatment or protection of plant propagation material or seeds, in particular grain seeds, tubers or rhizomes; for the treatment of roots, or for the treatment of the stems or leaves of the plant; as well as for the treatment of the roots, or alternatively of the fruits or other parts of the plant which possess a substantial economic or agronomic value.

Furthermore, said methods according to the invention may be carried out for the treatment of plants at numerous stages of their development, in particular for the treatment of the seeds, seedlings or seedlings for transplantation or plants for transplantation, or alternatively plants, fruits or harvests.

A class of diseases advantageously treated using the present invention may be given per crop:
Pome fruits (apples, pears, nashi): Penicillium expansum, Gloeosporium sp., Botrytis cinerea, Monilinia fructigena, Mucor sp., Monilinia laxa, Venturia inaequalis, Venturia pirina, Venturia nashiicola, Podosphaera leucotricha,
Stone fruits (peaches, plums, nectarines, cherries, apricots, almonds): Botrytis cinerea, Monilinia sp. (M. laxa, fructicola), Monilinia fructigena, Altemaria alternata, Colletotrichum gloeosporioides, Penicillium expansum, Cladosporium herbarum, Rhizopus stolonifer and Rhizopus oryzae, Wilsonomyces carpophilus (shot-hole),
Grapes (vine and table grapes): Botrytis cinerea, Aspergillus niger, Penicillium digitatum, Penicillium italicum, Rhizopus stolonifer, Altemaria alternata,
Kiwis: Botrytis cinerea,
Citrus fruits (oranges, lemons, limes, mandarins., grapefruits): Botrytis cinerea and Phytophthora citrophthora,
Bananas, plantains: skin disease (Colletotrichum musae), diseases of the crown (Fusarium semitectum, Fusarium moniliforme, Fusarium paledo-roseum, Acremonium sp., Botryodiplodia theo-bromae, Ceratocystis paradoxa, Colletotrichum musae, Mycosphaerella fijiensis, Mycosphaerella musicola, Nigrospora sphaerica),
Tomatoes: Alternaria alternata,
Melons: Botrytis cinerea, Altemaria solani, Altemaria alternata, Fusarium sp. (oxysporum, roseum, solani), Colletotrichum gloeosporioides, Penicillium sp., Phomopsis sp.,
Pineapples: Ceratocystis paradoxa,
Vegetable and fruit crops (strawberries, tomatoes, cucurbitaceous plants, lettuce, onion, leek, carrot): Botrytis cinerea, Botrytis spp. (squamosa, . . . ), Altemaria dauci, Alternaria brassicae, Altemaria alternata, Sphaerotheca macularis, Sphaerotheca fuliginea, Peronospora spp., Pseudoperonospora spp.,
Floral crops: Botrytis cinerea, Phytophthora spp.

Among these diseases, the most advantageous results are obtained on the following crops:
Pome fruits (apples, pears, nashi): Venturia inaequalis, Venturia pirina, Venturia nashiicola, Podosphaera leucotricha, or
Bananas, plantains: Mycosphaerella fijiensis, Mycosphaerella musicola, or
Grapes (vine and table grapes): Botrytis cinerea.

An additional aspect of the present invention relates to a product for simultaneous, separate, alternate or sequential application of pyrimethanil and of at least one phosphorous acid derivative, preferably fosetyl-aluminum.

The example which follows will allow better illustration of the various aspects of the present invention, in particular of the aspects relating to the compositions and to the methods according to the invention using said fungicidal compositions. However, this example does not in any way limit the scope of the present invention.

### EXAMPLE

Apple Tree—Venturia inaequalis

The following fungicides are compared:
Pyrimethanil at the dose of 20 g/hl and mixtures.
fosetyl-Al+pyrimethanil at the doses of 50+20 and 100+20 g/hl applied in a plant protection mixture volume of 1 200 l/ha.

The products are applied to an apple tree (Rome Beauty variety) which is sensitive to Venturia inaequalis.

The various products to be studied are sprayed every 7, 10 or 13 days (9, 7 and 6 applications in total respectively) in a program of treatment starting on 28 Mar. 2001.

Scores are awarded for the disease (% foliar surface area destroyed) on 14 May and 11 Jun. 2001. The results are expressed as % of leaves attacked.

Results

| | 14 MAY | 11 JUNE |
|---|---|---|
| Control | 58.5 | 100 |
| Pyrimethanil (20) - 7 days | 14.7 | 27.7 |
| fosetyl-Al + Pyrimethanil (500 + 200) - 7 days | 9.7 | 16.2 |
| fosetyl-Al + Pyrimethanil (1000 + 200) - 7 days | 7.8 | 8.7 |
| Pyrimethanil (200) - 10 days | 16.2 | 33 |
| fosetyl-Al + Pyrimethanil (500 + 200) - 10 days | 12.2 | 18.5 |
| fosetyl-Al + Pyrimethanil (1000 + 200) - 10 days | 6.3 | 15.7 |
| Pyrimethanil (200) - 13 days | 16.3 | 32 |
| fosetyl-Al + Pyrimethanil (500 + 200) - 13 days | 12.3 | 18.7 |
| fosetyl-Al + Pyrimethanil (1000 + 200) - 13 jours | 10.3 | 16.3 |

The addition of fosetyl-AI makes it possible to improve the persistence of the action of pyrimethanil. Thus, the activity obtained during successive applications every 10 to 13 days makes it possible to reach the activity normally obtained during weekly applications and therefore to substantially reduce the number of treatments which it is necessary to apply in order to control the development of the disease.

1. Fungicidal composition comprising pyrimethanil and at least one phosphorous acid derivative, phosphorous acid itself or one of its alkali or alkaline-earth metal salts.

2. Composition according to claim 1, comprising at least one metal phosphite.

3. Composition according to claim 1, comprising fosetyl-Al or fosetyl-Na.

4. Composition according claim 1, in which the ratio of the quantities of pyrimethanil and of phosphorous acid derivative ranges from 0.0005 to 250, preferably from 0.05 to 10, and still more preferably from 0.05 to 1.

5. Composition according to claim 4, in which the ratio of the quantities of pyrimethanil and of phosphorous acid derivative ranges from 0.1 to 10, preferably from 0.1 to 6, still more preferably from 0.1 to 1.

6. Composition according to claim 1, comprising pyrimethanil and fosetyl-Al in a quantity ranging from 0.1 to 1.

7. Composition according to claim 1, comprising pyrimethanil and phosphorous acid in a ratio ranging from 0.1 to 1.

8. Composition according to claim 1, also comprising a solid or liquid carrier which can be used in particular in the agricultural field, and optionally at least one surfactant and/or one or more auxiliary agents.

9. Method for the curative or preventive control of phytopathogenic organisms of plants by means of at least one composition according to any one of the preceding claims.

10. Method according to claim 9, for the curative or preventive control of phytopathogenic organisms of plants chosen from
Pome fruits (apples, pears, nashi): Penicillium expansum, Gloeosporium sp., Botrytis cinerea, Monilinia fructigena, Mucor sp., Monilinia laxa, Venturia inaequalis, Venturia pirina, Venturia nashiicola, Podosphaera leucotricha,
Stone fruits (peaches, plums, nectarines, cherries, apricots, almonds): Botrytis cinerea, Monilinia sp. (M. laxa, fructicola), Monilinia fructigena, Alternaria alternata, Colletotrichum gloeosporioides, Penicillium expansum, Cladosporium herbarum, Rhizopus stolonifer and Rhizopus oryzae, Wilsonomyces carpophilus (shot-hole),
Grapes (vine and table grapes): Botrytis cinerea, Aspergillus niger, Penicillium digitatum, Penicillium italicum, Rhizopus stolonifer, Alternaria alternata,
Kiwis: Botrytis cinerea,
Citrus fruits (oranges, lemons, limes, mandarins, grapefruits): Botrytis cinerea and Phytophthora citrophthora,
Bananas, plantains: skin disease (Colletotrichum musae), diseases of the crown (Fusarium semitectum, Fusarium moniliforme, Fusarium paledo-roseum, Acremonium sp., Botryodiplodia theo-bromae, Ceratocystis paradoxa, Colletotrichum musae, Mycosphaerella fijiensis, Mycosphaerella musicola, Nigrospora sphaerica),
Tomatoes: Alternaria alternata,
Melons: Botrytis cinerea, Alternaria solani, Alternaria alternata, Fusarium sp. (oxysporum, roseum, solani), Colletotrichum gloeosporioides, Penicillium sp., Phomopsis sp.,
Pineapples: Ceratocystis paradoxa,
Vegetable and fruit crops (strawberries, tomatoes, cucurbitaceous plants, lettuce, onion, leek, carrot): Botrytis cinerea, Botrytis spp. (squamosa, . . . ), Alternaria dauci, Alternaria brassicae, Alternaria alternata, Sphaerotheca macularis, Sphaerotheca fuliginea, Peronospora spp., Pseudoperonospora spp.,
Floral crops: Botrytis cinerea, Phytophthora spp.

11. Use of a phosphorus derivative for improving the persistence of the action of pyrimethanil.

12. Use according to claim 11 of a phosphorous acid derivative, of phosphorous acid itself or of one of its alkali or alkaline-earth metal salts.

13. Use, according to claim 11, wherein fostely-Al is used.

14. Use, according to claim 11, of fosetyl-Al in a ratio to pyrimethanil ranging from 0.1 to 1.

15. Use according to claim 11 for controlling either of the following diseases:
Pome fruits (apples, pears, nashi): Venturia inaequalis, Venturia pirina, Venturia nashiicola, Podosphaera leucotricha, or
Bananas, plantains: Mycosphaerella fyiensis, Mycosphaerella musicola, or
Grapes (vine and table grapes): Botrytis cinerea.

16. Composition according to claim 2, comprising fosetyl-Al or fosetyl-Na.

17. Composition according claim 2, in which the ratio of the quantities of pyrimethanil and of phosphorous acid derivative ranges from 0.0005 to 250, preferably from 0.05 to 10, and still more preferably from 0.05 to 1.

18. Composition according claim 3, in which the ratio of the quantities of pyrimethanil and of phosphorous acid derivative ranges from 0.0005 to 250, preferably from 0.05 to 10, and still more preferably from 0.05 to 1.

19. Use, according to claim 12, wherein fosetyl-Al is used.

20. Use, according to claim 12, of fosetyl-Al in a ratio to pyrimethanil ranging from 0.1 to 1.

21. Use, according to claim 13, of fosetyl-Al in a ratio to pyrimethanil ranging from 0.1 to 1.
